(19) United States
(12) Patent Application Publication
(10) Pub. No.: US 2009/0304489 A1
(43) Pub. Date: Dec. 10, 2009

(54) Method of Feeding Unstacker Apparatus For Unstacking Postal Items

(75) Inventors: Patrick Hours, Saint Peray (FR); Bernard Constant, Beaumont Les Valence (FR); Jean-Marc Teluob, Cornas (FR); Patrick Tetaz, Saint Romans (FR)

Correspondence Address: ROTHWELL, FIGG, ERNST & MANBECK, P.C., 1425 K STREET, N.W., SUITE 800, WASHINGTON, DC, 20005, US

(73) Assignee: SOLYSTIC, Gentilly Cedex (FR)

(21) Appl. No.: 11/912,187

(22) PCT Filed: May 30, 2007
(86) PCT No.: PCT/FR07/51351

§ 371 Date: Oct. 22, 2007

(30) Foreign Application Priority Data
Jul. 6, 2006 (FR) 0652832

(51) Int. Cl. B65G 59/00; B65H 1/14

(52) U.S. Cl. 414/795.4; 414/800

(57) ABSTRACT

A method of feeding flat items, in particular postal items, into unstacker apparatus (6) for unstacking flat items, which apparatus includes a feed magazine (3) with first and second paddles (8, 13), in which method a first stack of flat items (9) are moved in front of the first paddle towards the unstacker apparatus, comprises the steps consisting in:
forming the second stack of flat items (22) on edge behind the second paddle;
moving the second stack of flat items on edge and the second paddle until a junction is obtained between said first and second paddles; and
moving said first and second paddles together to behind the second stack of flat items.

This method contributes to facilitating building up of the first stack of flat items for feeding the unstacker apparatus.

### CROSS REFERENCE TO RELATED APPLICATIONS

This application is a 35 U.S.C. §371 National Phase Application from PCT/FR2007/051351, filed May 30, 2007, and designating the United States, which claims the benefit of France Application No. 0652832, filed Jul. 6, 2006.

### BACKGROUND OF THE INVENTION

1. Field of the Invention

The invention relates to the field of unstacking flat items disposed in a stack on edge, e.g. postal items, bank notes or checks, coupons, books, etc.

The invention relates more particularly to a method of feeding flat items into unstacker apparatus for unstacking flat items, which apparatus includes a feed magazine in which the flat items disposed on edge and constituting a current stack of flat items are moved in a certain direction of movement by a first paddle towards an unstacking face of the unstacker apparatus so as to be put in series. In this method a second paddle mounted to move along the axis defined by said certain direction is used to form a second stack of flat items disposed on edge behind said first paddle in the direction of movement, and said first and second paddles are manipulated so as to build up in front of the first paddle, in said certain direction of movement, the current stack of flat items on edge together with the flat items on edge of the second stack of flat items.

The unstacker apparatus is more particularly apparatus whereby the first flat item in the current stack of flat items that is in contact with the unstacking face is ejected in a direction perpendicular to the direction in which the flat items move through the feed magazine so that the flat items are put in series on edge, one behind another.

The invention applies particularly to handling large-format postal items or “flats”, but it can also be used for handling letters, e.g. in a postal sorting machine.

2. Discussion of the Background Art

In a postal sorting machine, the postal items to be sorted are generally brought to the inlet of the machine in bins in which they are stowed in stacks either on edge or laid flat (i.e. in piles). A bin full of postal items is tipped over onto the work surface and an operator takes the piles of postal items so as to store them in the feed magazine of an unstacker of the sorting machine.

Various methods are used to manipulate the piles of postal items in the feed magazine, such methods depending mainly on the configuration of the feed magazine and on the habits and preferences of the operators manipulating the postal items.

Typically, a feed magazine of a sorting machine unstacker has a storage surface for storing the postal items that is “dynamic” in that it is constituted by a horizontal conveyor belt (an endless conveyor belt extending horizontally) and a moving paddle driven by a motor, optionally such that its movement is synchronized with the movement of the conveyor belt, for the purpose of pushing a current stack of postal items to be unstacked towards the unstacking face of the unstacker.

In general, the paddle extends in a vertical plane that tilts slightly so as to support the stack of postal items.

The role of the operator is thus to build up the current stack of postal items that is pushed by the paddle.

In order to perform this operation, it can be possible for an operator to manipulate the paddle so as to form an empty space between the paddle and the current stack of postal items that is being unstacked, while, at the same time, taking hold of a new pile of postal items so as to dispose those items on edge in the empty space. That manipulation operation is impractical or even difficult to perform because the operator must both support and push the current stack of postal items with one hand and also use the other hand to take hold of a pile of postal items and to bring that pile of postal items in front of the paddle so as to build up the current stack of postal items. As a result, that manipulation can affect the throughput of the sorting machine.

Another manipulation consists in forming, behind the motor-driven paddle, a waiting stack of postal items. When the waiting stack of postal items is sufficiently large, the operator takes hold of the paddle and moves it so as to merge the postal items of the waiting stack with the postal items of the current stack. This manipulation is complicated due to the fact that, while the waiting stack of postal items is being formed, the operator must, at the same time, follow the movement of the paddle, which is moving continuously with the conveyor belt.

In order to mitigate the above drawbacks, U.S. Pat. No. 5,829,742 discloses another feed magazine arrangement for an unstacker of a postal sorting machine. Such a feed magazine 101, shown in FIG. 14, comprises a conveyor belt 102 constituting the dynamic storage surface and two moving paddles 103, 104 spaced apart longitudinally in the direction D in which the paddles move. Those two paddles comprise a first paddle 103 which faces the unstacking face of an unstacker 105 and which pushes the current stack 106 of postal items, and a second paddle 104 which is disposed behind the first paddle 103 in the direction D in which the postal items are moved towards the unstacking face. The two paddles are motor-driven in synchronized manner, and they are constrained to move in a manner such that their movement is also synchronized with the movement of the conveyor belt 102 constituting the dynamic storage surface. The empty space between the two moving paddles serves as a reserve zone for forming a waiting stack of postal items 107. In that case, after forming the waiting stack of postal items 107 between the two moving paddles 104, 103, the manipulation to be performed by the operator on the postal items consists in raising the first paddle 103 and putting it back in between the second paddle 104 and the waiting stack of postal items 107 so that the current stack 106 and the waiting stack 107 are merged. The operator then takes hold of the second paddle so as to move it backwards in order to form an empty space once again between the two paddles for the purpose of constituting the reserve zone. Although, with that arrangement, it is easier for the operator to form the waiting stack of postal items, the manipulation remains complicated and tedious since the paddles and thus the waiting stack are continuously moving and the operator must thus follow that movement. In addition, the operator must take hold of the postal items and carry them to the reserve zone and cannot merely slide them thereto because the second paddle obstructs the path from the bin containing the items to the reserve zone. The operator must also simultaneously concentrate efforts on keeping the postal items on edge in the reserve zone.

U.S. Pat. No. 4,052,052 also discloses apparatus for grouping together stacks of sheets and for inserting them into a bookbinding machine by means of motor-driven conveyors and of inserts pushed by paddles coupled to springs. Such apparatus is too complex to be implemented in a postal sorting machine.

Patent Documents EP 1 322 538 and EP 1 322 537 also disclose trolleys that can be coupled to an unstacker system of a postal sorting machine so as to feed it with postal items. Each of those trolleys has two longitudinal guides disposed on either side of the postal items as stood on edge, one of the longitudinal guides supporting two paddles serving to clamp a stack of postal items and the other longitudinal guide carrying a paddle serving to go behind said stack of postal items in order to push said stack towards the unstacker system after the other two paddles have been raised. Such apparatus requires three different paddles to be manipulated. In addition, the paddles are disposed on either side of the storage magazine, making them inconvenient to manipulate.

U.S. Pat. No. 5,829,742 also discloses a method of feeding unstacker apparatus for unstacking postal items, in which method a stack of postal items is picked up and placed on edge between first and second paddles. That method requires difficult manipulation of the postal items.

### SUMMARY OF THE INVENTION

The aim of the invention is to propose a method that facilitates insertion of the postal items into the sorting machine, and to design an ergonomic feed magazine that enables an operator to insert postal items into a postal sorting machine as quickly as possible with a small amount of effort.

To this end, the invention provides a method of feeding flat items into unstacker apparatus for unstacking flat items, which apparatus includes a feed magazine in which the flat items disposed on edge and constituting a current stack of flat items are moved in a certain direction of movement by a first paddle towards an unstacking face of the unstacker apparatus so as to be put in series, in which method a second paddle mounted to move along the axis defined by said certain direction is used to form a second stack of flat items disposed on edge behind said first paddle in the direction of movement, and in which method said first and second paddles are manipulated so as to build up in front of the first paddle, in said certain direction of movement, the current stack of flat items on edge together with the flat items on edge of the second stack of flat items, said method being characterized in that the magazine comprises a static surface and a dynamic surface that extend in said certain direction, said dynamic surface being disposed between said static surface and the unstacking face, and in that the method comprises the steps consisting in:
forming the second stack of flat items on edge on the static storage surface (4) behind said second paddle in said certain direction of movement;
moving the second stack of flat items on edge and the second paddle towards the first paddle in said certain direction of movement until the second paddle joins the first paddle;
moving said first and second paddles together to behind the second stack of flat items in said certain direction of movement; and
moving the current stack of flat items by means of the first paddle and of the dynamic storage surface.

The first and second paddles can advantageously be moved with one hand. The second paddle serves as a support for forming a new stack of flat items, and more particularly of postal items or of large-format postal items or “flats”, to be merged with the current stack that is being unstacked. Forming the new stack of postal items, e.g. on a static storage surface, is easy, and the two stacks can be merged by means of simple actions.

In particular implementations of the invention:
said first and second paddles are moved together to behind the second stack of flat items by means of a first movement that is substantially perpendicular to the axis defined by said certain direction of movement, and then by means of a second movement in translation along the axis defined by said certain direction of movement, and finally by means of a third movement substantially perpendicular to said axis defined by said certain direction of movement but in the opposite direction to the direction of said first movement;
after the third movement in translation, the second paddle is separated from the first paddle by a fourth movement in translation along said axis defined by said certain direction, but in the opposite direction; and
the second paddle is moved to an abutment disposed at said static storage surface.

The invention also provides unstacker apparatus for unstacking flat items, which apparatus includes a flat item feed magazine with a motor-driven first paddle mounted on a longitudinal edge of the magazine and suitable for moving in a certain direction of movement towards an unstacking face, a second paddle mounted to move on said edge of the magazine so as to be moved in said certain direction of movement, said second paddle being disposed behind said first paddle in said certain direction of displacement, said unstacker apparatus being characterized in that said second paddle is mounted to move freely on said edge of the magazine, and in that the magazine comprises a first storage surface for storing flat items on edge that is static, and a second storage surface for storing flat items on edge that is dynamic and that is disposed between the static first storage surface and the unstacking face, and in that said second paddle is suitable for being moved in a direction opposite from said certain direction of the movement from the dynamic storage surface towards the static storage surface to locking means for preventing the second paddle from moving freely.

The unstacker apparatus also has the following features:
said paddles are mounted in a manner such that they can be moved in a direction that is perpendicular to said certain direction of movement, and in which junction apparatus is provided that unites said first and second paddles when they are moved together, face against face, in said direction perpendicular to said certain direction of movement;
said junction apparatus is constituted by an opening formed in the first paddle and by a lug disposed in the second paddle to be inserted into said opening when said paddles are face against face;
said paddles are mounted on the edge of the magazine, each via a corresponding pantograph extending in a plane that is substantially perpendicular to said certain direction of movement;
the second paddle is hinged to the corresponding pantograph about an axis of rotation that is perpendicular to said certain direction of movement so as to be retracted out of the magazine;
the locking means are activated at the end of a movement of said second paddle along the axis defined by said certain direction of movement;
said static storage surface is provided with a notched surface with retaining notches, these non-return notches being, more particularly, semi-punched-out recesses disposed in a plurality of parallel rows; and
each of the paddles is provided with a respective manipulation handle, the handles on the paddles being mutually offset in a direction that is substantially perpendicular to said direction of movement.

The apparatus of the invention simplifies and greatly facilitates the manipulations required of the operator for inserting postal items into the machine so that the operator tires less and so that the efficiency of the machine is improved.

### BRIEF DESCRIPTION OF THE DRAWINGS

The invention can be better understood on reading the following description and on examining the accompanying drawings. The description is given merely by way of non-limiting indication of the invention. In the drawings:

FIGS. 1 to 6 are perspective views of a feed magazine of a sorting machine at various stages of the method of the invention;

FIG. 7 is a perspective view of the feed magazine of the sorting machine shown in the preceding figures, with the second paddle in the retracted position;

FIG. 8 is a diagrammatic view from above of the feed magazine of the invention;

FIG. 9 is a perspective view from behind of the first paddle;

FIG. 10 is a perspective view from behind of the second paddle;

FIG. 11 shows the pantograph and the inside of the second paddle;

FIG. 12 is a diagrammatic view of the junction apparatus making it possible to unite the paddles;

FIG. 13 is a diagrammatic view of the means for locking the second paddle; and

FIG. 14 is a highly diagrammatic view of a prior art feed magazine.

### DETAILED DESCRIPTION OF THE PREFERRED EMBODIMENTS

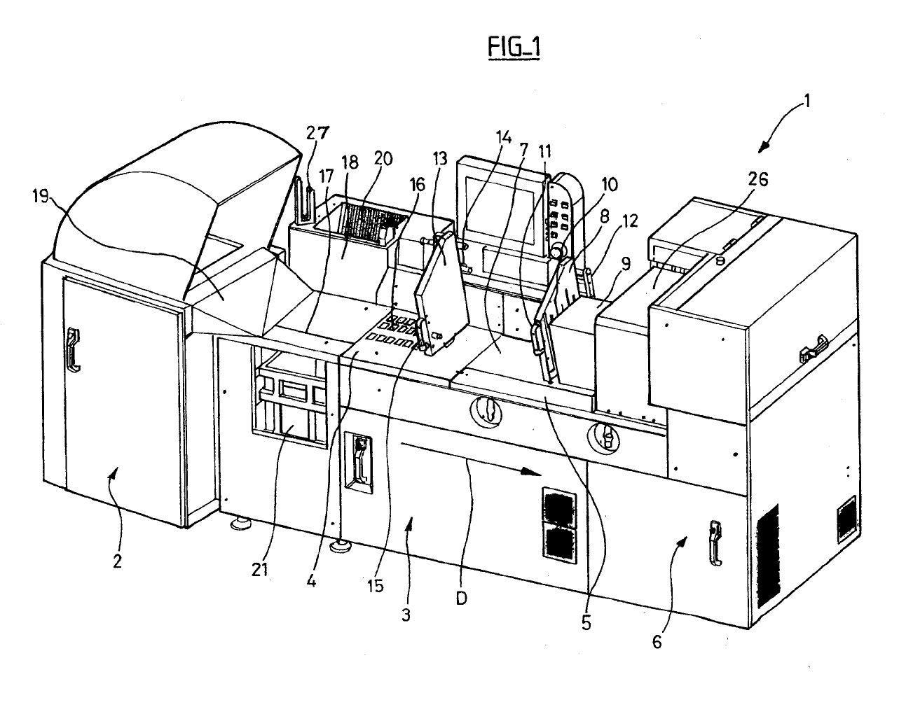

FIG. 1 is a fragmentary view of a sorting machine 1 with a feed magazine designed ergonomically, i.e. so as to make it easier for the operator to insert postal items into the sorting machine and so as to improve the efficiency thereof.

From left to right in FIG. 1, the sorting machine 1 has a bin tipper 2, a feed magazine 3 with a static storage surface 4 and a dynamic storage surface 5, and an unstacker system or apparatus 6. Below, for reasons of simplicity, terms relating to “forward” or “backward” movement and terms relating to “front” and “back” positioning are understood to be relative to the direction of movement of the postal items through the feed magazine, as represented by arrow D, the “front” being in the vicinity of the unstacker system 6 and the “back” being in the vicinity of the bin tipper 2.

The dynamic storage surface 5 comprises a conveyor belt 7 that advances flat and horizontally in the direction of movement D towards an unstacking face of the unstacker system 6, and a first motor-driven paddle 8 that advances above the conveyor belt 7 in the direction of movement D towards the face of the unstacker system 6. The motor-driven moving paddle 8 has a plane front face facing the unstacker system 6 and tilts slightly relative to the vertical, the distance between the front face of the paddle 8 and the unstacker system 6 increasing with increasing height. The motor-driven moving paddle 8 pushes and holds on edge the postal items resting thereagainst, while said postal items are advancing on the conveyor belt towards the unstacker system. For example, the conveyor belt 7 and the moving paddle 8 have a common motor drive system that automatically manages their advance with said advance being servo-controlled to the unstacking of the postal items. However, the conveyor belt and the moving paddle can also be designed with individual and separate motor drive systems making it possible to act on their respective speeds of movement so that the postal items arrive at the unstacking face as vertically as possible. As shown in FIG. 1, a first stack 9 of postal items 9 held on edge against the front face of the motor-driven moving paddle 8 advances in front of the moving paddle 8 on a conveyor belt 7 towards the unstacker system 6. The aim of the invention is to enable said stack of postal items disposed in front of the moving paddle 8 to be built up simply while it is being unstacked.

The first paddle 8 is shown more particularly in detail in FIG. 9. An edge 52 of the paddle 8 that faces the operator is provided with a handle 11 so as to make it easier to take hold of the paddle and manipulate it. The motor-driven moving paddle 8 is mounted on a pantograph 12 enabling the paddle 8 to be moved in vertical translation. The operator can thus raise the paddle 8 above the postal items disposed on edge on the storage surface. The pantograph 12 is coupled to the edge of the paddle opposite from the handle 11, and it is mounted outside the storage surface so as to leave said storage surface unobstructed when the paddle is raised. A spring placed suitably inside the paddle makes it possible to compensate for a fraction of the weight of the paddle so as to avoid the operator having to expend too much effort when raising the paddle. Since the paddle is mounted to move in vertical translation, it is easy to take hold of the handle 11 and said handle 11 remains close to the body of the operator continuously, thereby reducing the effort required of the operator.

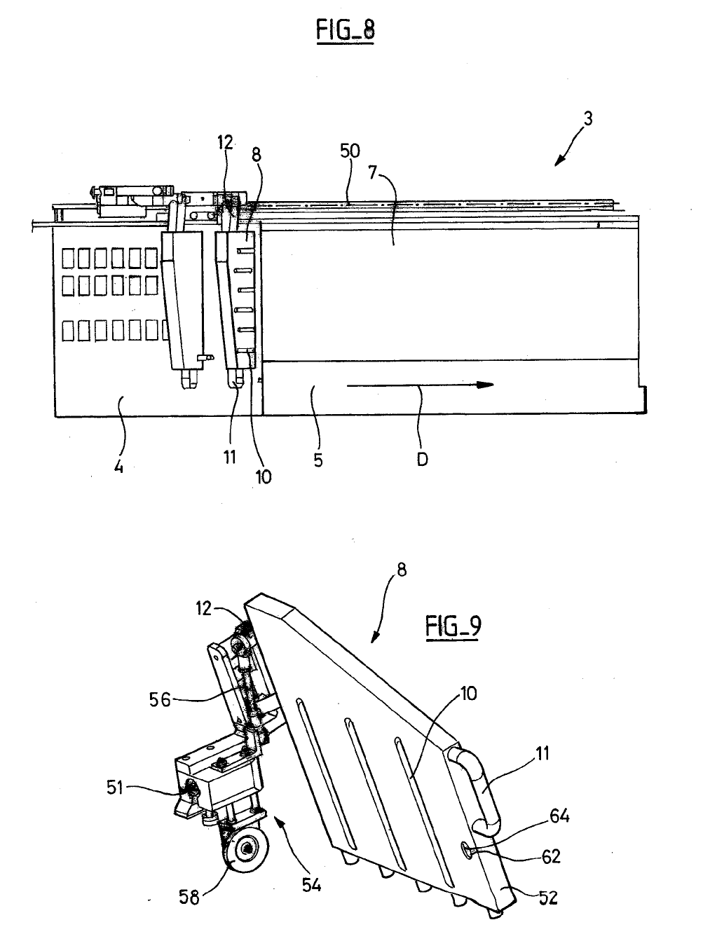

The pantograph is mounted on a rail 50 that can be seen in FIG. 8, that is disposed on a longitudinal edge of the feed magazine, and that extends in the direction of movement D while being set back from the storage surface. The pantograph 12, and therefore the paddle 8, can slide along the rail 50. The rail 50 passes more particularly through a groove 51 equipped with guide means and formed in the structure of the pantograph 12. When the paddle 8 is lowered, i.e. when it is in contact with the conveyor belt 7, a clutch mechanism 54 coupled to the pantograph 12 clutches the pantograph and paddle assembly to a motor-driven chain advancing along the rail, thereby driving the paddle forwards. The clutch mechanism further includes a unidirectional sprocket wheel that allows the paddle to be moved forwards manually to an additional extent but that prevents the paddle from moving backwards, so as to hold the postal items properly by exerting forward pressure on said postal items. When the paddle 8 is raised, the clutch mechanism 54 is declutched from the motor-driven chain, and the paddle 8 in the high position can slide freely forwards or backwards along the rail. The clutch mechanism 54, which can be seen in FIG. 9, is more particularly constituted by a rod 56 fastened to one of the branches of the pantograph 12 and driving in vertical translation a sprocket wheel 58 that is mounted on a unidirectional ball bearing as a function of the movement of the branch of the pantograph. When the paddle 8 is lowered, said branch of the pantograph 12 is lowered, so that the sprocket wheel 58 descends and comes to engage a motor-driven chain. Conversely, when the paddle is raised, the sprocket wheel rises and disengages from the chain. The unidirectional ball-bearing makes it possible for the operator to move the paddle forwards when the paddle is in the low position.

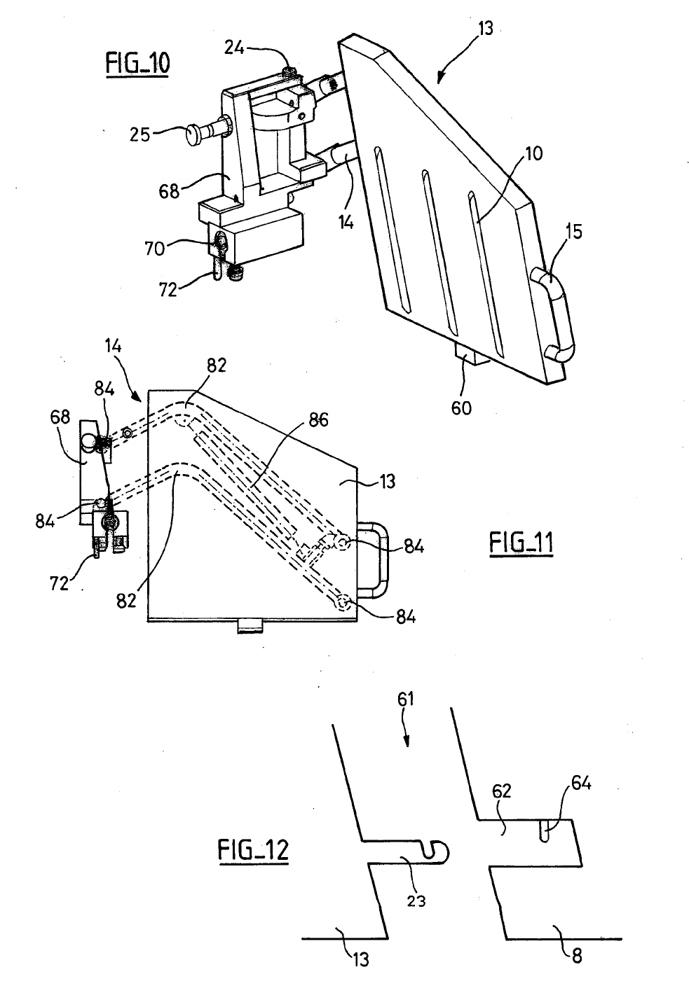

The feed magazine also has a second paddle 13 disposed behind the first paddle 8 in the direction of movement D. Said second paddle 13, which is substantially identical to the first paddle 8, is shown in more detail in FIGS. 10 and 11. Said second paddle 13 is mounted on a pantograph 14 enabling said paddle to move in vertical translation, the pantograph 14 itself being mounted in a manner such as to be able to slide on the same rail 50 as the pantograph 12. The pantograph 14 does not have any clutch mechanism so that the paddle 13 mounted on the pantograph 14 is not automatically driven forwards when it is in the low position and can slide freely along the rail forwards or backwards along the axis defined by the direction of movement D, merely under the action of the operator manipulating the paddle by holding it by a handle 15 facing said operator, regardless of whether the paddle is in the high position or in the low position.

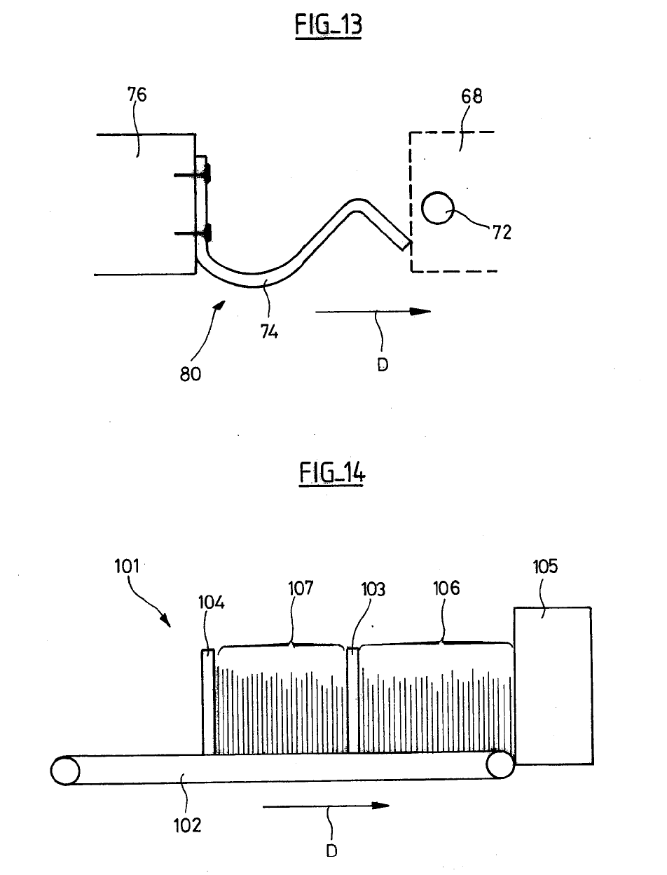

When the paddle is as far back as possible on the feed magazine, it is locked in position by means of a locking system and can be unlocked by the operator exerting forward force. This locking system is described below with reference to FIG. 13 and it is, for example, made up of a spring comprising a blade provided with an L-bend, against which spring an abutment 72 formed on the structure of the pantograph 14 comes to act. The paddle is then situated above the static storage surface 4, as shown in FIG. 1. The static storage surface has a surface with lower adhesion, i.e. that is very slippery, and is provided with a region for verifying the size of the postal items and a region for accumulating postal items. The surface of the region for accumulating postal items is provided with retaining notches 16. On the region for verifying the size of the postal items, a line 17 drawn on the surface in the direction of movement D serves as a reference for verifying the length of the postal items to be inserted into the machine when said postal items are in abutment against a vertical wall 18. Said vertical wall 18 has a particular height that serves as a reference for verifying the height of the postal items to be inserted into the machine. The region for verifying the size further includes a thickness gauge 27 for verifying the thickness of the postal items. The various references make it possible to remove postal items that are outside the size limits, i.e. that exceed, for example 260 millimeters (mm) in height, 360 mm in length, and 20 mm or 32 mm in thickness.

A ramp 19 specially adapted to facilitate tipping postal items 4 out of a bin disposed on the bin tipper 2 and putting them on edge on the static storage surface 4 serves to form a junction between the bin tipper 2 and the feed magazine 3.

Other details of the sorting machine are presented below during the description of the manipulations performed by the operator for inserting the postal items into the sorting machine and given step-by-step with reference to the successive figures.

As shown in FIG. 1, a first stack 9 of postal items on edge advances automatically on the conveyor belt 7 in front of the first paddle 8 in the low position towards the unstacker system which puts the postal items from the stack 9 into series and sends them one-by-one into the sorting machine. The second paddle 13 is as far back as possible on the feed magazine 5 and in the low position, and it is therefore locked in the waiting position.

A bin containing postal items to be inserted into the machine is then brought in the bin tipper 2 and is tipped over to one side, with its opening facing the ramp 19. The operator, who has both hands free, takes hold of a pile of postal items and stands them on edge in the region for verifying the size of the postal items and aligns them against the vertical wall 18, with their faces perpendicular to the direction of movement D. The operator then identifies the postal items that are outside the size limit, i.e. the postal items that extend beyond the line 17 and/or beyond the vertical wall 18, and removes them from the machine sorting by throwing them into a hopper 20. The hopper 20 is disposed just behind the vertical wall 18 and is provide with a chute that directs the over-size postal items to a collection bin 21 disposed beneath the region for verifying the size of the postal items. Disposed in this way, the collection bin 21 for collecting over-size postal items is easy for the operator to access and to maneuver.

The operator then slides the postal items, still on edge and with their faces perpendicular to the direction of movement D, over the static storage surface until they come to bear against the back face of the second paddle 13. The paddle 13 remains in place without any action from the operator since it is locked. The postal items have then slid forwards over the retaining notches 16 and said retaining notches retain the bottom edges of the postal items that tend naturally to slide backwards. Said retaining notches 16 or anti-slip notches thus prevent the postal items from slipping down onto the static storage surface.

The component material of the static storage surface must be very slippery in order to minimize the friction of the postal items sliding over it, and thus to minimize damage to the postal items and the efforts made by the operator. On a slippery surface, postal items on edge and bearing against a vertical wall tend to slip down, with the bottom edges of the postal items standing on the slippery surface slipping away from vertical wall. This problem is particularly prevalent when manipulating postal items that are flexible and light in weight. In order to remedy that problem, the slippery surface of the region for accumulating postal items is notched so as to enable the postal items to move forwards and to prevent the bottom edges of the postal items from slipping backwards when said postal items are resting against the back face of the second paddle, the retaining notches serving as abutments for or retaining the bottom edges of the postal items. Various types of retaining notches 16 can be used, based on the principle of fish scales or of seal skin. The retaining notches are more particularly disposed in a matrix configuration on the postal item accumulation region.

In the particular embodiment shown in the figures, said retaining notches are constituted by a plurality of rows of semi-punched-out recesses, e.g. three such recesses, extending in the surface parallel to the direction of movement D. The term “semi-punched-out recess” is used to mean a sort of wedge-shaped recess formed in sheet of metal with a profile that is in the shape of a right-angled triangle, with the front side being open. Three rows of semi-punched-out recesses are used rather than a single row with longer punched-out recesses in order to prevent the postal items from jamming in the openings of the semi-punched-out recesses, which they might if said openings were large enough for a postal item to fit therein. In FIGS. 1 to 7, each row comprises seven semi-punched-out recesses.

The static storage surface is more particularly formed by an embossed metal sheet in order to limit electrostatic interactions with the postal items. The semi-punched-out recesses are more particularly formed by stamping the metal sheet, i.e. by tearing the surface and deforming the metal sheet to from the sloping surface. Such a manufacturing method is particularly advantageous because it is simple and makes it possible to obtain notches having sharp angles and against which the postal items cannot slip backwards. For example, the semi-punched-out recesses have a height of 3 mm and a length in the direction of movement of in the range 30 mm to 40 mm. A height of 3 mm is sufficient to retain the bottom edges of the postal items, and the sliding slope of the semi-punched-out recesses is sufficiently shallow not to hinder forward sliding of the postal items. The notches in the notched surface therefore have a vertical profile in the direction of movement D that is shaped in the manner of fish scales.

In another embodiment of the invention, the notched surface could be formed merely by a stepped or terraced plate descending in the direction of movement D.

A certain number of postal items then, without any action being required of the operator, stands against the back face of the second paddle 13, on the static storage surface 4. The facts that the paddle is held stationary in the locked position and that the static storage surface is stationary, and the presence of the retaining notches make it easier to arrange the postal items on edge and more particularly to align them against a vertical wall.

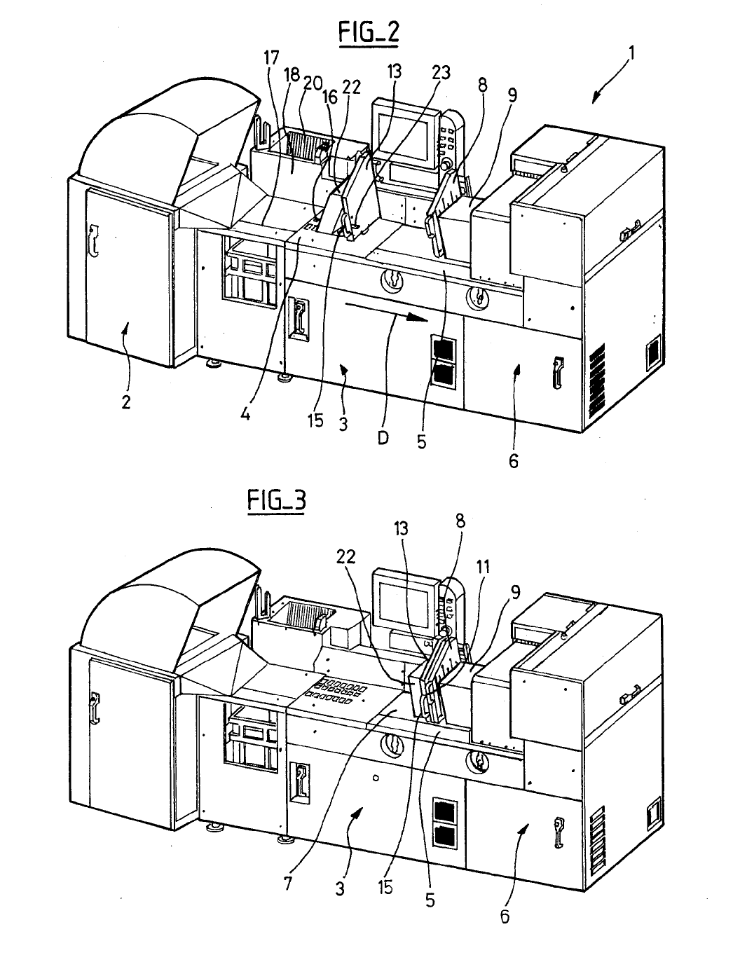

The operator then brings other piles of postal items behind the postal items already standing against the second paddle until, behind the second paddle, a second stack of postal items 22 has been formed that is deemed to be large enough to be merged with the first stack of postal items 9 that is already being unstacked. This configuration is shown in FIG. 2.

When the operator considers that it is necessary, said operator decides to merge the first and second stacks of postal items 9, 22. The decision is quite subjective and depends on the habits of the user, e.g. once the first stack 9 has been halved.

The operator then takes hold of the second paddle 13, by means of the handle 15, with the right hand, places the left hand behind the second stack of postal item 22 and slides both the second paddle 13 and the second stack of postal items 22 together, i.e. with the postal items still bearing against the back face of the paddle, to behind the first paddle 8. The operator releases the second paddle from the locking system by exerting a forward force. The force necessary for unlocking is calculated to be slightly greater than the force exerted by postal items on edge and bearing against the paddle, and to enable the second stack of postal items to be formed without having to hold the second paddle manually. As shown in FIG. 10, a pad 60 is arranged under the second paddle so as to enable it to be moved with less effort.

Junction apparatus arranged on the paddles makes it possible to unite the two paddles when they are face against face, i.e. when the front face of the second paddle is against the back face of the first paddle. Said junction apparatus 61 is more particularly described with reference to FIG. 12. A lug 23, also visible in FIG. 2, is arranged on the front face of the second paddle 13. Said lug 23 has a hook-shaped end, with the hook shape extending upwards, and it is arranged in a manner such as to be insertable into an opening 62 arranged in the back face of the first paddle 8. Said opening is more particularly oblong in shape as shown in FIG. 9. A small tab 64 is arranged inside the opening, in the top portion thereof, so that, when the two paddles are face against face and when the operator raises the second paddle, the hook on the lug 23 catches on the small tab 64 in the opening 62. The two paddles 8, 13 are then united and can be moved upwards together by manipulating the second paddle 13 only, by the handle 15.

FIG. 3 shows the second paddle 13 advanced against the back face of the first paddle 8. The second stack of postal items 22 has been pushed forwards together with the second paddle 13, and against the back face thereof. The lug 23 has then been inserted into the opening 62. The second stack of postal items 22, and the second paddle find themselves on the dynamic storage surface 5 on top of the conveyor belt 7.

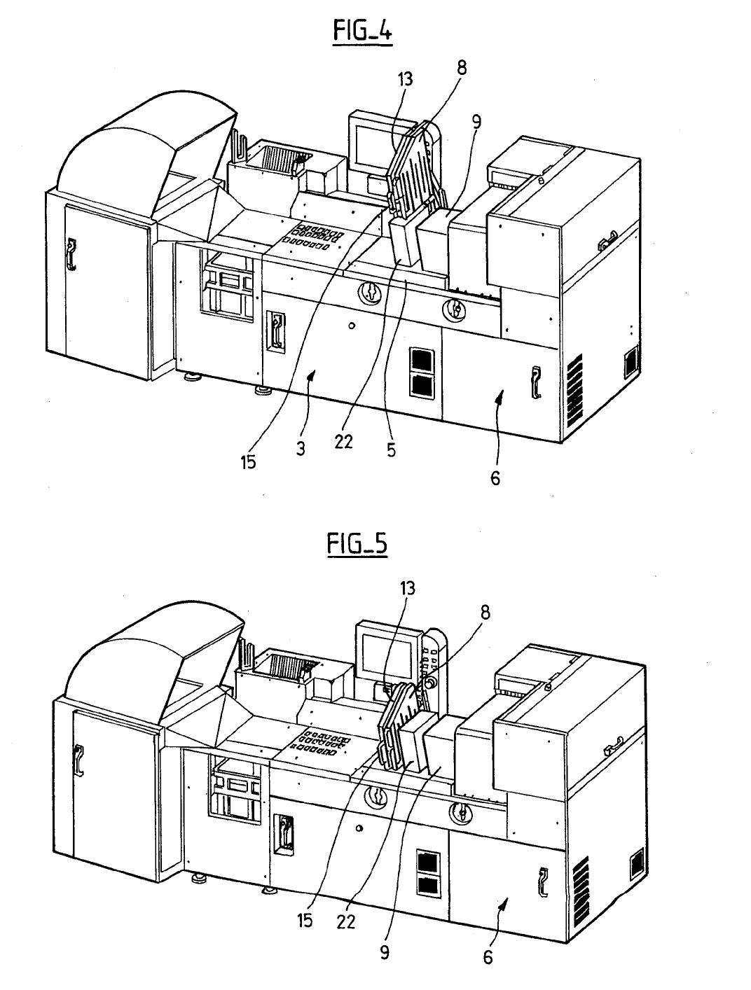

As shown in FIG. 3, the handles 11 and 15 of the first and second paddles are offset vertically relative to each other. The operator can thus bring the second paddle against the first paddle by holding it by the handle 15, without being hindered by the handle 11. At no time does the operator need to let go of the handle 15 in order to perform the next step consisting in uniting and in simultaneously raising the two paddles 8, 13, as shown in FIG. 4.

The operator continues to maintain forward pressure on the second stack of postal items 22 with the left hand placed behind the second stack, and raises the second paddle by holding it by the handle 15. The hook on the lug 23 then catches on the small tab 64 in the opening, thereby constraining the two paddles 8, 13 to be raised simultaneously. By means of this simple action, the operator raises the two paddles to above the postal items.

The operator then returns the two paddles 8, 13 to the low position behind the second stack of postal items 22, as shown in FIG. 5, by moving the two united paddles over the second stack of postal items 22.

The operator then pushes the second paddle forwards, still by holding it by its handle 15, and therefore pushes the first paddle so as to merge the two stacks of postal items 9, 22 and so as to push them forwards.

In another alternative, the two stacks 22, 9 can be merged by action consisting in the operator using the left hand to push the second stack forwards while both paddles 8, 13 are raised.

With the two paddles 8, 13 back in the low position, the first paddle resumes its automated forward motion, and the hook on the lug 23 has released the small tab 64 in the opening 62 so that the two paddles 8, 13 are disunited. The operator can then cause the second paddle 13 only to move backwards by sliding it in the low position, still by holding it by the handle 15 with the right hand.

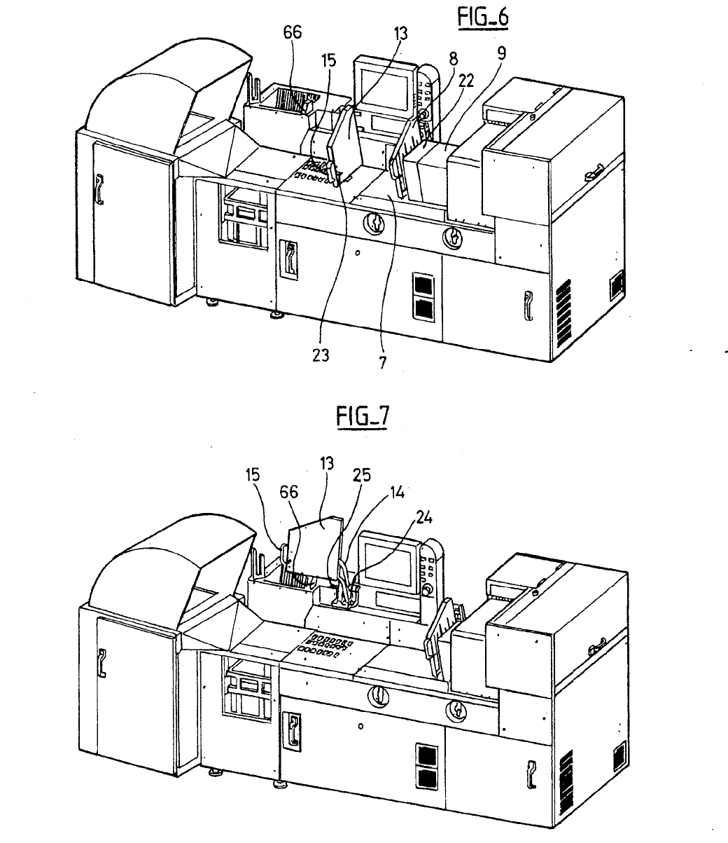

As can be seen in FIG. 6, the two stacks 9, 2 are merged on the conveyor belt 7 while bearing against the front face of the first paddle 8 and they are brought automatically towards the unstacker system 6. The second paddle has been moved back by the operator to the locking system, and it is locked on top of the notched surface.

In FIG. 6, the configuration is once again as in FIG. 1. The operator can thus repeat the above-described operations so as to top up continuously the stack of postal items situated in front of the first paddle.

As shown in FIG. 7, the second paddle can be retracted and locked out of the way of the postal items on the feed magazine. This configuration makes it possible to insert the postal items into the machine by using the first paddle only, as is known from the prior art. The pantograph 14 is more particularly mounted on a hinge 24 so that the paddle can be moved in rotation from the retracted position to the working position and vice versa. A catch 25 makes it possible to lock the second paddle in one position or another. The second paddle 13 is more particularly locked in the retracted position by the bottom edge of the paddle being inserted into and resting in a groove in a locking support 66, as is shown in FIG. 7.

FIG. 10 shows the second paddle 13 in more detail. The pantograph 14 carrying the paddle 13 is mounted on a support structure 68 having a vertical hinge 24 about which the pantograph 14 and the paddle 13 can pivot. In FIG. 10, the paddle is locked in the in-use position in which it is deployed on the feed magazine by means of a catch 25 inserted into a bore formed in the element of the hinge 24 that carries the pantograph 14. The catch 25 is pushed and held inside the said bore by means of a compression spring. In order to bring the paddle into the retracted position and in order to lock it in that position, the operator then pulls on the catch 25 to release the hinge, pivots the paddle 13 through 90° about the hinge 24 and lets go of the catch. The support structure 68 is also provided with a passageway 70 extending in the direction of movement and in which the rail 50 is mounted so that the paddle slides along the rail. The support structure 68 is also provided with an abutment 72 extending vertically below the structure 68.

The abutment 72, which is seen from below in FIG. 13, makes it possible to lock the paddle above the static storage surface and more particularly just in front of the retaining notches in the direction of movement. The locking system 80 is constituted by a spring comprising a blade 74 provided with an L-bend, which spring is mounted on a frame 76 of the sorting machine and is stressed by the abutment 72 mounted on the moving support structure 68 of the pantograph 14. When the paddle 13 is moved backwards, the abutment 72 bears against the front portion of the blade 74 so that said blade moves out of the way and allows the abutment to go past, which abutment becomes locked between the back portion of the blade and the frame. Sufficient pressure must be exerted forwards in order to move the blade 74 out of the way of the abutment 72 and in order to release the paddle. A damper system can also be provided so as to prevent the structure of the paddle 13 hitting the frame 76 too violently.

The FIG. 11 shows the construction of the pantograph 14 of the paddle 13 in more detail. The pantograph 14 is made up of two L-shaped branches 82 fastened on fixed hinges 84 at one end in the paddle and at the other end on the structure 68. Such a pantograph 14 makes it possible for the paddle 13 to move in translation or more particularly for said paddle to move with its bottom edge moving parallel to the surface of the feed magazine 3. A compensation spring 86 is arranged between the two branches 82 of the pantograph 14 in a manner such as to load while the paddle is being lowered, and such as to unload while the paddle is being raised. The compensation spring compensates in part for the weight of the paddle so that the effort to be made by the operator to raise the paddle is reduced.

FIGS. 1 to 7 show an anti-noise cover 26 disposed at the inlet of the unstacker system 6 for the purpose of attenuating the noise generated by unstacking the postal items. Said cover can be drawn over the feed magazine 3 or retracted into the stacker system 6. A magnet is fastened to the pantograph 12 of the first paddle 8 and it attracts a metal element disposed in register on the anti-noise cover. Once the first paddle has advanced sufficiently towards the unstacker system, said first paddle becomes coupled to the anti-noise cover by means of the magnet, thereby pushing the cover into the unstacker system as it advances and pulling the cover over the unstacker system when it is raised and moved backwards. The anti-noise cover is detached automatically from the paddle when it is drawn to its maximum extent. The fact that the movement of the anti-noise cover is coupled to the movement of the first paddle makes it possible to minimize the noise due to the unstacking without any particular action being required of the operator.

Both the front face of the first paddle (see FIGS. 1 to 7) and the back face of the second paddle (FIG. 10) have slide strips 10. Said slide strips 10 facilitate sliding of the postal items bearing directly against them, and therefore make it easier to raise the paddles 8, 13 above the stacks of postal items 9, 22 during the step shown in FIG. 4. The end postal item in the stack bearing against the face of the paddle is not raised with the paddle, which could give rise to disturbance of the order in which the postal items are inserted or to difficulties in merging the first and second stacks of postal items.

For the same reason, the back face of the first paddle 8 is also provided with slide strips 10 (see FIG. 9), it being possible for said back face to be used when the first paddle is used on its own, i.e. when the second paddle is retracted, to form a stack of postal items to be merged with the stack of postal items disposed against the front face of said first paddle, by raising said first paddle.

Naturally, the invention is in no way limited to the details of the above-described embodiment, but rather it extends to any variant that is obvious to the person skilled in the art.

For example, in a particular embodiment of the invention, the back face of the second paddle is tilted slightly relative to the vertical, the bottom of said back face being further away from the unstacker apparatus than the top, as shown in the figures. Such a tilt facilitates holding the postal items while the second stack of postal items is being prepared on the postal item accumulation region or notched static storage surface.

In addition, the motor drive for the conveyor belt and the motor drive for the motor-driven moving first paddle can be separate in order to improve the manner in which the postal items are disposed when they reach the unstacking face.

Finally, in the embodiment as described above, reference is made to paddles that are moved out of the way on the feed magazine by moving in vertical translation but paddles can also be designed to be pulled by the operator in a movement in horizontal translation. Paddles can also be designed to move out of the way on the feed magazine by moving in rotation as is known from U.S. Pat. No. 5,829,742.

It is also possible to design a static storage surface in which the retaining notches are not formed by stamping, but rather they are in the form of retractable catches. By turning a knurled wheel, the operator can then, as necessary, deploy or not deploy the retaining catches from the static storage surface.

1. A method of feeding flat items into an unstacker apparatus for unstacking flat items, which apparatus includes a feed magazine in which the flat items disposed on edge and constituting a current stack of flat items are moved in a certain direction of movement by a first paddle towards an unstacking face of the unstacker apparatus so as to be put in series, a second paddle mounted to move along the axis defined by said certain direction to form a second stack of flat items disposed on edge behind said first paddle in the direction of movement, wherein said first and second paddles are capable of being manipulated so as to build up in front of the first paddle, in said certain direction of movement, the current stack of flat items on edge together with the flat items on edge of the second stack of flat items, and wherein the magazine includes a static surface and a dynamic surface that extend in said certain direction, said dynamic surface being disposed between said static surface and the unstacking face, said method comprising the steps of:
forming the second stack of flat items on edge on the static storage surface behind said second paddle in said certain direction of movement;
moving the second stack of flat items on edge and the second paddle towards the first paddle in said certain direction of movement until the second paddle joins the first paddle;
moving said first and second paddles together to behind the second stack of flat items in said certain direction of movement; and
moving the current stack of flat items by means of the first paddle and of the dynamic storage surface.

2. A method according to claim 1, in which said step of moving said first and second paddles together to behind the second stack of flat items includes performing a first movement that is substantially perpendicular to the axis defined by said certain direction of movement, and performing a second movement in translation along the axis defined by said certain direction of movement, and performing a third movement substantially perpendicular to said axis defined by said certain direction of movement but in the opposite direction to the direction of said first movement.

3. A method according to claim 2, further comprising, after the third movement, separating the second paddle from the first paddle by a fourth movement in translation along said axis defined by said certain direction, but in the opposite direction.

4. A method according to claim 2, in which the first movement and the second movement are movements in substantially vertical translation.

5. A method according to claim 2, in which the first movement and the second movement are movements in substantially horizontal translation.

6. A method according to claim 2, in which the first movement and the second movement are movements in rotation in a substantially vertical plane.

7. A method according to claim 3, in which separating the second paddle from the first paddle includes moving the second paddle to an abutment disposed at said static storage surface.

8. A method according to claim 1, in which the flat items are postal items.

9. A method according to claim 8, in which the postal items are large-format items or “flats”.

10. An unstacker apparatus for unstacking flat items, said unstacker apparatus comprising an unstacking face and a flat item feed magazine with a motor-driven first paddle mounted on a longitudinal edge of the magazine and suitable for moving in a certain direction of movement towards said unstacking face, a second paddle mounted to move on said edge of the magazine so as to be moved in said certain direction of movement, said second paddle being disposed behind said first paddle in said certain direction of displacement and mounted to move freely on said edge of the magazine, said magazine further including a first storage surface for storing flat items on edge that is static, a second storage surface for storing flat items on edge that is dynamic and that is disposed between the static first storage surface and the unstacking face, and a locking mechanism configured to engage the second paddle so as to prevent the second paddle from moving freely, and wherein said second paddle, when it is joined with the first paddle so that the two paddles are moved together, is suitable for being moved in a direction opposite from said certain direction of the movement from the dynamic storage surface towards the static storage surface to said locking mechanism.

11. Apparatus according to claim 10, in which said paddles are mounted in a manner such that they can be moved in a direction that is perpendicular to said certain direction of movement, and in which junction apparatus is provided that unites said first and second paddles when they are moved together, face against face, in said direction perpendicular to said certain direction of movement.

12. Apparatus according to claim 11, in which said junction apparatus is constituted by an opening formed in the first paddle and by a lug disposed in the second paddle to be inserted into said opening when said paddles are face against face.

13. Apparatus according to claim 10, in which said paddles are mounted on the edge of the magazine, each via a corresponding pantograph extending in a plane that is substantially perpendicular to said certain direction of movement.

14. Apparatus according to claim 13, in which the second paddle is hinged to the corresponding pantograph about an axis of rotation that is perpendicular to said certain direction of movement so as to be retracted out of the magazine.

15. Apparatus according to claim 10, in which the locking mechanism is activated at the end of a movement of said second paddle along the axis defined by said certain direction of movement.

16. Apparatus according to claim 15, in which the locking mechanism includes a spring comprising a blade provided with an L-bend, which spring is stressed by an abutment.

17. Apparatus according to any one of claim 10, in which said static storage surface is provided with a notched surface with notches for retaining the flat items.

18. Apparatus according to claim 17, in which the retaining notches are semi-punched-out recesses formed in a metal sheet and disposed in a plurality of parallel rows.

19. Apparatus according to claim 10, in which the static storage surface includes a verification region provided with reference indicators defining a certain size of flat item.

20. Apparatus according to claim 19, in which said reference identifiers are disposed on two mutually perpendicular surfaces of said static storage surface so as to make it possible to perform size verification on two dimensions of the flat items.

21. Apparatus according to claim 19, in which a hopper is provided for collecting the flat items that are over-size, which hopper is disposed beside said size verification region, said hopper being disposed so as to direct a flat item into a stowage space for stowage of a removable bin, disposed below said verification region.

22. Apparatus according to claim 10, provided with a slidably-mounted anti-noise cover mounted to move along the axis defined by said displacement direction and surrounding said unstacking face, and in which apparatus coupling apparatus is provided for coupling together said cover and said first paddle, which coupling apparatus constrains said first paddle and said cover to move together.

23. Apparatus according to claim 22, in which said coupling apparatus is constituted by magnetic coupling apparatus including a magnet.

24. Apparatus according to claim 10, in which each of the paddles is provided with a respective manipulation handle, the handles on the paddles being mutually offset in a direction that is substantially perpendicular to said direction of movement.

25. Apparatus according to claim 13, in which each pantograph is provided with a weight-compensating spring.

26. Apparatus according to claim 10, in which the paddles are provided with slide strips.

27. A machine for handling postal items, said machine being characterized in that it includes apparatus according to claim 10.
